(19) United States
(12) Patent Application Publication
(10) Pub. No.: US 2004/0154475 A1
(43) Pub. Date: Aug. 12, 2004

(54) Baking utensils with indicia

(76) Inventors: Bradford W. Shaw, Chicago, IL (US); Carly White, Brooklyn, NY (US); Tim Kennedy, Staten Island, NY (US); Charita Patamikakorn, Brooklyn, NY (US); Boris Kontorvich, Brooklyn, NY (US)

Correspondence Address: Harold V. Stotland, Seyfarth Shaw LLP, Suite 4200, 55 East Monroe Street, Chicago, IL, 60603-5803, US

(21) Appl. No.: 10/754,380

(22) Filed: Jan. 9, 2004

Related U.S. Application Data
(60) Provisional application No. 60/438,836, filed on Jan. 9, 2003.

(51) Int. Cl. A47J 43/18

(52) U.S. Cl. 99/426

(57) ABSTRACT

A cooking utensil includes a base wall, an upstanding peripheral wall structure integral with the base wall and a peripheral flange extending laterally outwardly from the peripheral wall structure with indicia thereon including plural equidistantly spaced first indicia respectively alternating with plural, equidistantly spaced second indicia, so that each first and second indicium is disposed directly opposite a like indicium. Plural, evenly-spaced additional indicia may be disposed on an upper surface of the base wall.

### RELATED APPLICATION

This application claims the benefit of the filing date of copending U.S. Provisional Application No. 60/438,836, filed Jan. 9, 2003.

### BACKGROUND

This application relates to cooking utensils and, in particular, to cooking vessels or containers, such as baking pans, dishes, sheets and the like.

It is known to provide cooking utensils, such as baking vessels or containers, in a variety of shapes and sizes, depending upon the food item being cooked. For example, there are a variety of baking pans and dishes for baking food items, such as pies, cakes, pizzas, fudge, candy and the like. Food items which are baked in such vessels are typically baked in a single mass or body and, after the food item is cooked, it is frequently desired to cut or slice it into smaller individual portions for serving or the like. For this purpose, the user must typically “eyeball” the finished food item in determining where to make cuts or slices.

For example, in a rectangular vessel, such is used for baking certain cakes, casseroles, quiches, confections and the like, it may be desirable to cut the contents of the vessel into individual rectangular portions by making a number of equidistantly spaced-apart transverse cuts across the width of the vessel and then a series of equidistantly spaced-apart longitudinal cuts across the length of the vessel. It is often difficult, particularly for some users, to place adjacent cuts at equal distances apart, and it may also be difficult to cut a straight line across the vessel.

An additional difficulty is added in cutting the contents of circular vessels, such as pie pans, pizza pans and the like. Typically, such contents would be cut into generally triangular wedges. In this case, the difficulty is spacing the cuts at equiangularly-spaced apart locations. Sometimes users attempt to overcome this difficulty by making diametrical cuts at 90° apart and then making additional cuts, as needed, midway between the diametrical perpendicular cuts. However, in this case the difficulty is in accurately locating the center of the vessel so that the cuts can be made along true diameters.

Sometimes a utensil, such as a cookie tray or a sheet, is used for cooking a plurality of discrete items, such as cookies, individual confections, or the like. In such cases, it is often difficult to evenly distribute the items on the bottom wall of the utensil so as to maximize the number of items without having them run together during baking

### SUMMARY

This application discloses cooking utensils which avoid disadvantages of prior utensils while affording additional structural and operating advantages.

An aspect of the utensils disclosed herein, is that they provide indicia to facilitate accurate slicing of baked contents of the vessel.

Another aspect is the provision of a utensil with indicia to facilitate accurate positioning of discrete items on or in the utensil.

Another aspect is the provision of utensils of the type set forth which are characterized by simple and economical construction and ease of use.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a top plan view of a first embodiment of utensil in the form of a cooking vessel;

FIG. 2 is a sectional view taken generally along the line 2-2 in FIG. 1;

FIG. 3 is a top plan view of another embodiment of cooking vessel;

FIG. 4 is a perspective view of still another embodiment of cooking vessel; and

FIG. 5 is a top plan view of the vessel of FIG. 4.

### DETAILED DESCRIPTION

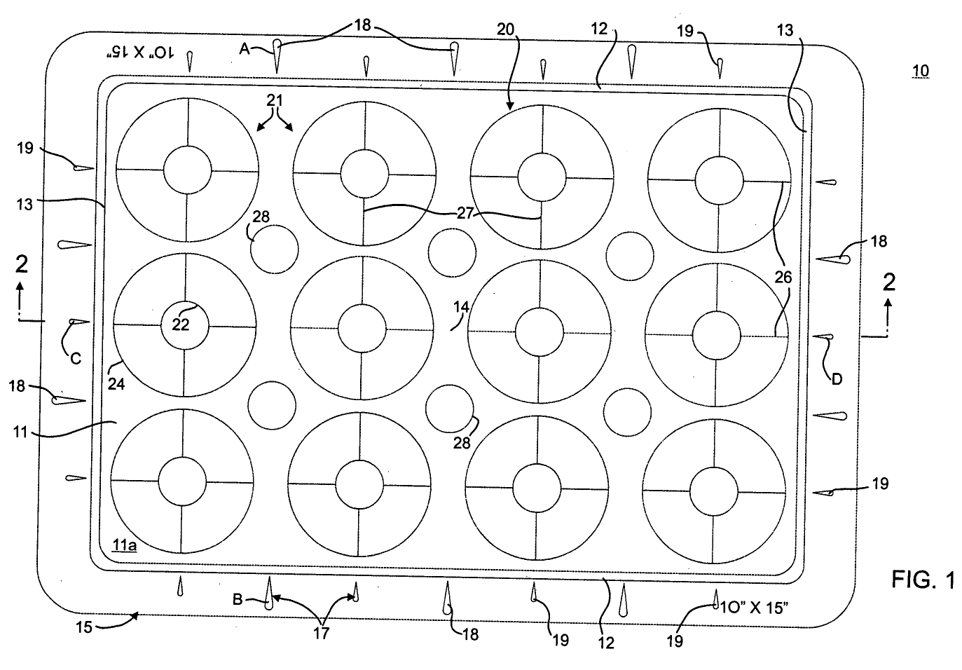

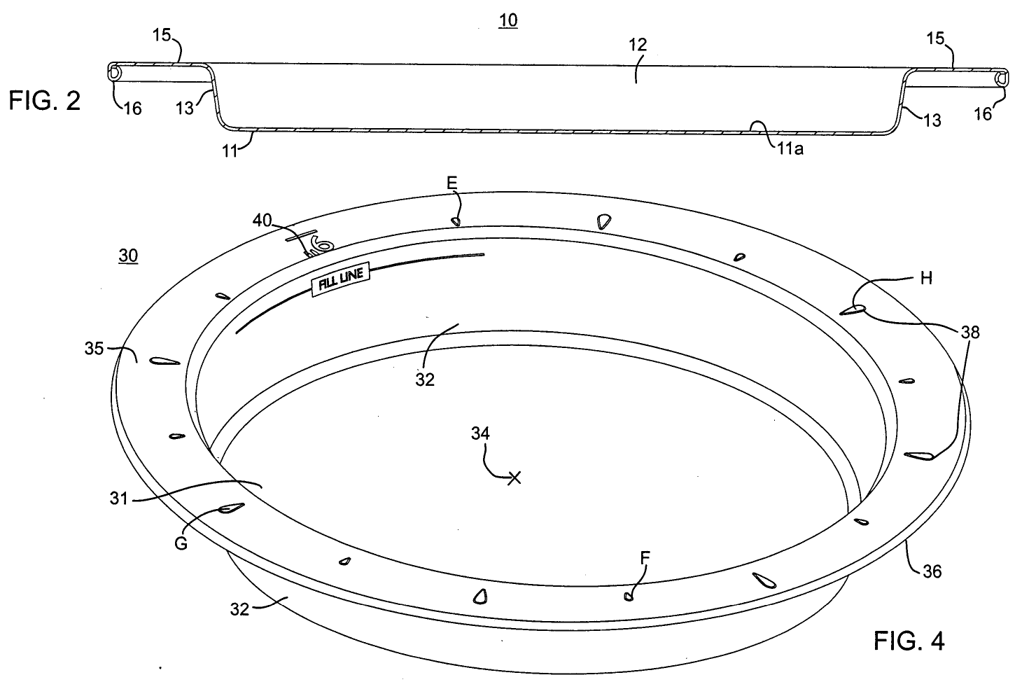

Referring to FIGS. 1 and 2, there is illustrated a utensil in the nature of a baking pan 10, which is a shallow pan of the type which may be used for baking items such as confectionery items, cookies and the like. The pan 10 is generally rectangular in shape, having a bottom wall 11 integral along the opposite sides thereof with upstanding side walls 12 and along the ends thereof with upstanding end walls 13, the bottom wall 11 having an upper surface 11a with a center point 14 thereon. Integral with the peripheral wall structure which is formed by the side walls 12 and end walls 13 is a laterally outwardly extending peripheral flange 15, which extends around the entire periphery of the pan, and may have a rolled-under distal edge 16, as can be seen in FIG. 2. The pan 10 may be of unitary one-piece construction, and may be formed of any suitable oven-proof material, such as suitable metal, glass, ceramic or the like.

Formed on the upper surface of the flange 15 are a plurality of spaced-apart indicia or markings 17 including a first set of large markings 18, which are equidistantly spaced-apart along each side and each end of the pan 10, and a plurality of small markings 19, which are also equidistantly spaced-apart along the sides and ends of the flange 15 and respectively alternate with the large markings 18 along each such side and end. Each of the large markings 18 along the sides of the pan 10 is disposed directly opposite a corresponding large marking 18 on the opposite side, so that the two align parallel to the end edges of the bottom wall 11. Likewise, each of the small markings 19 along the pan sides is directly opposite a corresponding small marking on the opposite side. In a like manner, each of the large and small markings along the ends of the vessel is directly opposite a corresponding marking on the opposite end, so as to be aligned therewith along a line parallel to the side edges of the bottom wall 11. Thus, the marking A is directly opposite the marking B and the marking C is directly opposite the marking D.

In the illustrated embodiment, there are three large markings 18 along each side of the pan 10, spaced so as to cooperate to divide the length of the bottom wall 11 into quarters, and there are two such markings along each end, cooperating to divide the width of the bottom wall 11 into thirds. The small markings 19 are disposed midway between adjacent large markings 18 and, accordingly, cooperate therewith to divide the length of the bottom wall 11 into eighths and the width of the bottom wall into sixths.

In use, after the food item in the pan 10 is baked, the markings 18 and/or 19 may be utilized to facilitate slicing of the contents of the pan 10 into equal-sized portions. In this regard, transversely opposing indicia, such as the markings A and B, can be utilized to guide a slice so that a transverse slice across the width of the pan begins and ends along the same transverse line. Similarly, longitudinally opposed indicia, such as markings C and D, can be used to guide a longitudinal slice. If the user wishes to make certain that the cut not only begins and ends along the same transverse or longitudinal line, but also adheres to the straight line, she can place a straight edge across the flange 15 between the two opposed markings and use it as a guide for the knife or other cutting implement. Thus, it will be appreciated that, using only the large markings 18, the contents of the pan 10 can accurately be divided into 12 equal square portions whereas, if both the large and small markings 18 and 19 are used, the contents can be divided into 48 equal squares.

Since the pan 10 is of the shallow tray type, which could be used as a cookie sheet or the like for baking individual cookies, candies etc., there are provided on the upper surface 11a of the bottom wall 11 additional indicia, generally designated 20, to facilitate the even spacing of discrete items, such as individual dollops of cookie or candy batter, on the bottom wall 11. More particularly, the indicia 20 include a plurality of sets 21 of concentric circles, 12 such sets being illustrated. Each set 21 includes an inner circle 22 and an outer circle 24. Indicia (not shown) may be provided to indicate the diameters of the circles. In the illustrated embodiment, the inner circles 21 may have a 1-inch diameter and the outer circles 24 may have a 3-inch diameter. The sets 21 are arranged in equidistantly spaced-apart rows and columns, defined by longitudinal lines 26 and transverse lines 27. Line indicia may be provided on the upper surface 11a along the lines 26 and 27, the line indicia including straight line segments extending between inner and outer circles of each set. Accordingly, even distribution of 12 cookies or the like can be effected by placing each portion of cookie dough at the center of one of the sets 21. Each group of four sets 21 has provided at the center thereof an additional 1-inch diameter circle 28, the circles 28 also being arranged in rows and columns. Line indicia may also be provided on the upper surface 11a, the line indicia being made up of straight-line segments extending between adjacent indicia 21 or 28 in a row or column and between indicia and adjacent side walls or end walls of the pan. Thus, each circle 28 is equidistantly spaced from adjacent sets 21, and each set 21 is equidistantly spaced from adjacent circles 28. By the use of these additional circles 28, a total of 18 items may be evenly distributed on the bottom wall 11. If desired, each set 21 could include more than two concentric circles.

Preferably, each of the markings 18 and 19 and the bottom wall indicia 21 and 26-28 are formed by embossing. The indicia 17 may be formed by embossing the underside of the flange 15 so that the indicia may be raised slightly above the upper surface of the flange, while the indicia 21 and 26-28 may be formed by embossing the upper surface 11a of the bottom wall 11, so that the embossments may slightly deform the bottom surface of the bottom wall 11. It will be appreciated that the indicia could also be formed by etching or the like or by other suitable surface marking techniques.

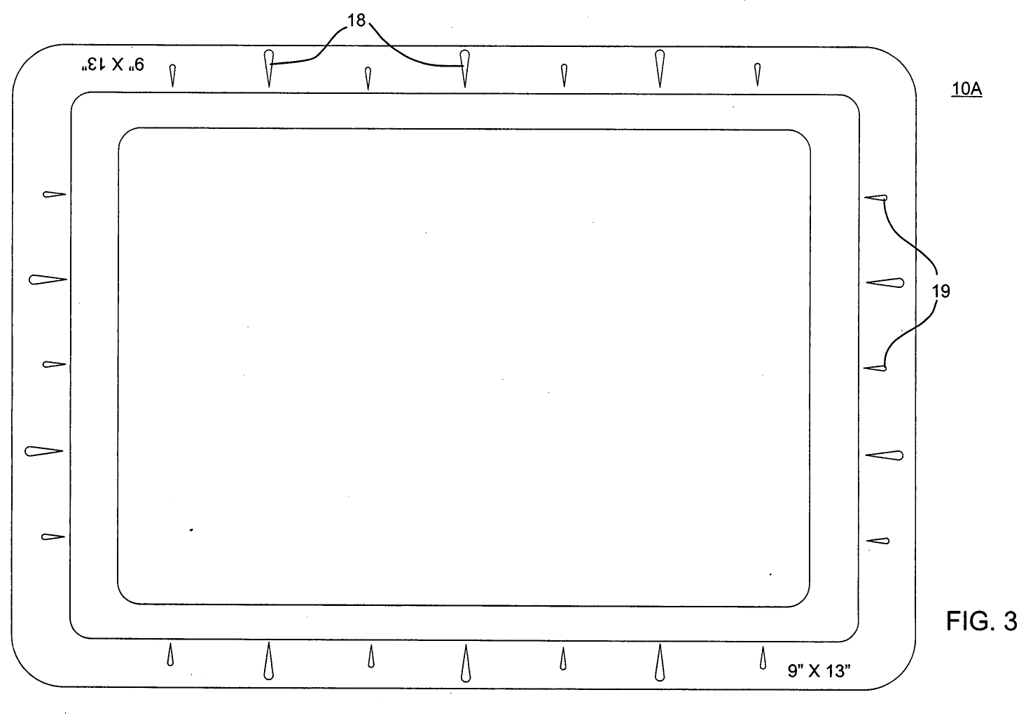

Referring to FIG. 3, there is illustrated a baking pan 10A, which is similar to the baking pan 10, except that it is a slightly smaller size with deeper side walls, and lacks the bottom-wall indicia 20. However, it is provided with the same number of large and small markings 18 and 19 arranged in substantially the same fashion as in the pan 10 of FIG. 1. It will be understood that, in either of the pans 10 and 10A, if desired, the markings 18 and 19 could be provided only along the sides or only along the ends of the vessel. Also, while specific numbers of the markings 18 and 19 have been illustrated, it will be appreciated that any desired number could be utilized, depending upon the number and sizes of portions into which it is desired to divide the contents of the pan 10.

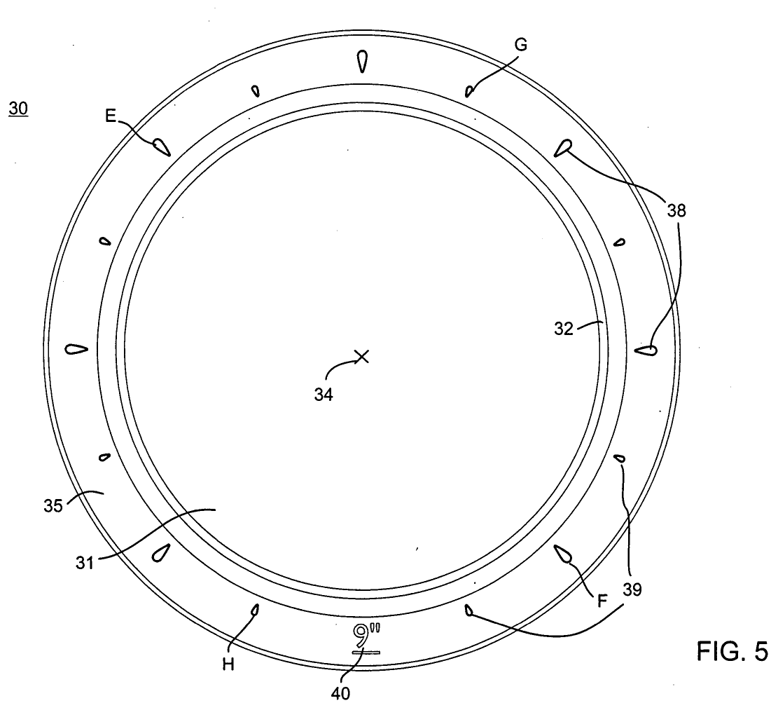

Referring to FIGS. 4 and 5, there is illustrated a circular cooking utensil in the nature of a pie pan 30, which has a circular bottom wall 31 integral around its periphery with an upstanding sidewall 32, which may slope slightly outwardly so as to define a substantially frustoconical shape. The bottom wall 31 has an imaginary center point 34. Integral with the sidewall 32 at its upper edge and extending laterally outwardly therefrom along the entire circumference thereof is a flange 35, which may be provided with a rolled-under distal edge 36. The pan 30 may be formed of any of the same types of materials as were described above for the pan 10. Formed on the upper surface of the flange 15 are a plurality of equiangularly spaced-apart large indicia or markings 38 and a plurality of equiangularly spaced-apart relatively small markings 39, which respectively alternate with the large markings 38. A pan-size indicium 40 may also be provided. The markings 38 and 39 may be formed in the same manner as was described above for the markings 18 and 19.

It will be appreciated that the markings 38 and 39 are so arranged that each marking 38 is disposed diametrically opposite a corresponding marking 38, such as the markings E and F and, similarly, each of the small markings 39 is disposed diametrically opposite a corresponding marking 39, such as the markings G and H. In use, in order to cut the contents of the pan 30 into equal-sized wedges, diametrically opposed markings, such as E and F, are utilized to guide a diametrical cut which will pass through the center point 34. Again, in order to insure that the cut follows a straight line, a straight edge may be utilized to span the flange 35 and guide the cutting implement. While a pie pan 30 is illustrated, it will be appreciated that the principles of the invention may be utilized with other types of circular cooking vessels, such as pizza pans, cake pans, and the like. It will be also understood that any desired number of indicia or markings 38 and 39 could be utilized.

From the foregoing, it can be seen that there has been provided improved baking utensils with indicia which facilitate sectioning of the contents of the utensil into equal-sized portions and evenly-spaced placement of plural discrete items on a bottom wall of the utensil.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution.

What is claimed is:

1. A cooking utensil comprising:
a base wall,
an upstanding peripheral wall structure integral with the base wall along its periphery,
a peripheral flange integral with the peripheral wall structure along its periphery and extending laterally outwardly therefrom, and
a set of indicia disposed on the flange and including plural first indicia substantially equidistantly spaced apart peripherally of the wall structure and plural second indicia substantially equidistantly spaced apart the peripherally of the wall structure and respectively alternating with the first indicia.

2. The cooking utensil of claim 1, wherein each first indicium is disposed directly opposite a corresponding first indicium on an opposed portion of the wall structure, and each second indicium is disposed directly opposite a corresponding second indicium on an opposed portion of the wall structure.

3. The cooking utensil of claim 1, wherein the first indicia are larger than the second indicia.

4. The cooking utensil of claim 1, wherein the distance between adjacent first indicia is the same as the distance between the adjacent second indicia.

5. The cooking utensil of claim 1, wherein the base wall is circular in shape.

6. The cooking utensil of claim 5, wherein the first indicia are arranged in pairs of diametrically opposed indicia, and the second indicia are arranged in pairs of diametrically opposed indicia.

7. The cooking utensil of claim 1, wherein the indicia are disposed on an upper surface of the flange.

8. The cooking utensil of claim 1, wherein the base wall has an upper surface, and further comprising a set of additional indicia disposed at evenly spaced locations on the upper surface of the base wall.

9. A cooking utensil comprising:
a rectangular base wall,
an upstanding peripheral wall structure integral with the base wall along its periphery and including opposed end walls and opposed side walls,
a peripheral flange integral with the peripheral wall structure along its periphery and extending laterally outwardly therefrom, and
a set of indicia disposed on the flange and including plural first indicia substantially equidistantly spaced along each end wall and along each side wall and plural second indicia substantially equidistantly spaced along each end wall and along each side wall,
each first indicium being disposed directly opposite a corresponding first indicium on an opposed wall and each second indicium being disposed directly opposite a corresponding second indicium on an opposed wall.

10. The cooking utensil of claim 9, wherein the first indicia are larger than the second indicia.

11. The cooking utensil of claim 9, wherein the distance between adjacent first indicia is the same as the distance between the adjacent second indicia.

12. The cooking utensil of claim 9, wherein the indicia are disposed on an upper surface of the flange.

13. The cooking utensil of claim 9, wherein the base wall has an upper surface, and further comprising a set of additional indicia disposed at evenly spaced locations on the upper surface of the base wall.

14. A cooking utensil comprising:
a base wall having a flat planar upper surface, and
a plurality of evenly spaced first indicia disposed on the upper surface and a plurality of evenly spaced second indicia disposed on the upper surface,
each first indicium being equidistantly spaced from adjacent second indicia, and each second indicium being equidistantly spaced from adjacent first indicia.

15. The cooking utensil of claim 14, wherein the first indicia are arranged in parallel first rows and parallel first columns perpendicular to the first rows, and the second indicia are arranged in parallel second rows and parallel second columns perpendicular to the second rows.

16. The cooking utensil of claim 15, wherein the first rows alternate with the second rows and the first columns alternate with the second columns.

17. The cooking utensil of claim 16, and further comprising first line indicia including straight-line segments extending along the first rows and the first columns.

18. The cooking utensil of claim 14, wherein each of the indicia is circular in shape.

19. The cooking utensil of claim 18, wherein each first indicium includes a plurality of concentric circles.

20. The cooking utensil of claim 14, and further comprising first line indicia including straight-line segments extending along the first rows and the first columns.
